(19) United States
(12) Patent Application Publication
(10) Pub. No.: US 2026/0253530 A1
(43) Pub. Date: Aug. 27, 2026

(54) EMISSIVE ELEMENT POWER CONTROL

(71) Applicant: Arm Limited, Cambridge (GB)

(72) Inventors: Ali Mohammed Gamaleldin Gouda Ellabban, London (GB); Daren Croxford, Swaffham Prior (GB)

(21) Appl. No.: 19/066,007

(22) Filed: Feb. 27, 2025

(51) Int. Cl. G09G 3/32

(52) U.S. Cl. CPC G09G 3/32; G09G 2330/021; G09G 2354/00; G09G 2360/18

(57) ABSTRACT

Example methods, apparatuses, or articles of manufacture are disclosed herein that may be utilized, in whole or in part, to facilitate or support one or more operations or techniques for affecting control signals to a display device to selectively reduce power to at least some individually controllable emissive elements in the display device. In one implementation, some of the individually controllable emissive elements of a display device may be configured to not emit visible light while a remaining portion continues presentation of the visible image according to one or more conditions local to the display device.

### FIELD

The field relates generally to display technology and, more specifically, to display devices with individually controllable emissive elements.

### BACKGROUND

One class of self-emissive light emitting diodes (LEDs) enables individual pixels of a display device to be controlled without need for a backlight. Organic LEDs (OLEDs), for example, use organic material, such as molecular or long polymer materials, to emit light when an electric current is applied. MicroLEDs use tiny rows of microscopic LEDs to operate as individual pixels. Perovskite LEDs (PeLED) is a type of LED that uses perovskite crystals. In a PeLED, the perovskite material acts as the emissive layer and emits light directly when an electric current is applied. Quantom dot LEDs (QLEDs) feature nanoscale semiconductors that emit light in the presence of an electric current.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 is a schematic block diagram of a computing device, consistent with an example embodiment.

FIG. 2 is a diagram of a display device, consistent with an example embodiment.

FIGS. 3A-3C are diagrams of touch sensors integrated with display panels, consistent with example embodiments.

FIG. 4 is a depiction of aspects of a pixel in a display device formed from multiple individually controllable emissive elements, consistent with an example embodiment.

FIGS. 5A-5C are depictions of aspects of display devices, consistent with example embodiments.

FIGS. 6A and 6B are depictions display devices, consistent with example embodiments.

FIG. 7 is a flow diagram of an emissive element power control process, consistent with an example embodiment.

FIG. 8 is a flow diagram of an emissive element power control process, consistent with an example embodiment.

Reference is made in the following detailed description and accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described and serve to illustrate how elements of these examples may be applied to various purposes or embodiments. Other embodiments exist, and logical, mechanical, electrical, and other changes may be made.

Display panels used in combination with a computing device may consume considerable energy. As another example, battery resources of a smart phone may be particularly stressed if a display intensity is increased to a maximum setting, such as when using the device on a sunny day.

In some scenarios, a portion of a display panel screen of a computing device may not be visible, such as by a user's hands touching a display panel screen of a smart phone, for example, thus blocking visibility of some portion of the display panel screen.

Thin-film transistor (TFT) and/or liquid crystal display (LCD) based display devices typically use a backlight source. Light from such a backlight source may be modulated by individually controllable TFT and/or LCD for presentation of an image. Display devices formed from individually controllable emissive elements (ICEEs) such as light emitting diodes (LED) are becoming increasingly more common. With such an LED based display device, individual LEDs may be individually switched on or off. Thus, power consumed by such an LED based display device may largely depend on how many LEDs are switched on, and intensity levels to which the LEDs are emitting. In some scenarios, a portion of a display panel screen may not be visible to a user. This may occur, for example, if a user's hands is touching a display panel screen, blocking a portion of a displayed image at the point.

According to one embodiment, individual PeLEDs may be selectively configured as optical sensors which may be used to roughly determine which portion of the screen is covered/obscured.

Computing devices employing individually controllable (e.g., individually powered) emissive elements (e.g., LED displays) may consume a substantial portion of a power budget (e.g., from a battery source in a tablet or smartphone) from presenting images. There is a demand for features of portable computing device to reduce power usage by a display device while not significantly impairing quality of an image presented on the display device.

One particular embodiment is directed to a method comprising: detecting one or more portions of a display device that are at least partially obscured from view, the display device comprising a plurality of individually controllable emissive elements; and affecting control signals to the display device to selectively reduce power to at least some of the individually controllable emissive elements corresponding to at least one of the one or more portions of the display device.

Another particular embodiment is directed to a controller device comprising: circuitry to detect one or more portions of a display device that are at least partially obscured from view, the display device comprising a plurality of individually controllable emissive elements; and circuitry to affect control signals to the display device to selectively reduce power to at least some of the individually controllable emissive elements corresponding to at least one of the one or more portions of the display device.

Yet another particular embodiment is directed to a non-transitory computer-readable medium storing computer-readable code for fabrication of an apparatus comprising: circuitry to detect one or more portions of a display device that are at least partially obscured from view, the display device comprising a plurality of individually controllable emissive elements; and circuitry to affect control signals to the display device to selectively reduce power to at least some of the individually controllable emissive elements corresponding to at least one of the one or more portions of the display device.

Yet another particular embodiment is directed to a method comprising: applying control signals to individually controllable emissive elements of a display device to present a visible image from the display device, at least some of the individually controllable emissive elements to be selectively configurable either to emit visible light or not emit visible light; detecting one or more conditions in an environment local to the display device; and selectively configuring a portion of the at least some of the individually controllable emissive elements to not emit visible light while a remaining portion of the individually controllable emissive elements continue presentation of the visible image based, at least in part, on the detected one or more conditions.

Yet another particular embodiment is directed to a controller device comprising: circuitry to apply control signals to individually controllable emissive elements of a display device to present an image visible from the display device, at least some of the individually controllable emissive elements to be selectively configurable either to emit visible light or not emit visible light; circuitry to detect one or more conditions in an environment local to the display device; and circuitry to selectively configure a portion of the at least some of the individually controllable emissive elements to not emit visible light while a remaining portion of the individually controllable emissive elements continue presentation of the visible image based, at least in part, on the detected one or more conditions.

Yet another particular embodiment is directed to a non-transitory computer-readable medium storing computer-readable code for fabrication of an apparatus comprising: circuitry to apply control signals to individually controllable emissive elements of a display device to present an image visible from the display device, at least some of the individually controllable emissive elements to be selectively configurable either to emit visible light or not emit visible light; circuitry to detect one or more conditions in an environment local to the display device; and circuitry to selectively configure a portion of the at least some of the individually controllable emissive elements to not emit visible light while a remaining portion of the individually controllable emissive elements continue presentation of the visible image based, at least in part, on the detected one or more conditions.

In an embodiment, a computing device for controlling power to an emissive element is shown and described herein. In one embodiment, such a computing device may modify control signals to individually controllable emissive elements of a display device, such as a display device that is part of client device such as a smart phone or tablet. In one aspect, a computing device may reduce power or block power to one or more emissive elements of a display, throttle resolution of the display, and/or configure one or more emissive elements to harvest ambient light as stored energy. Power consumed by such a display device may be reduced. Further, operations to reduce power to be consumed by emissive elements may be performed without compromising image quality. In another aspect, the operations may extend battery life to portable computing devices such as tablets and smartphones.

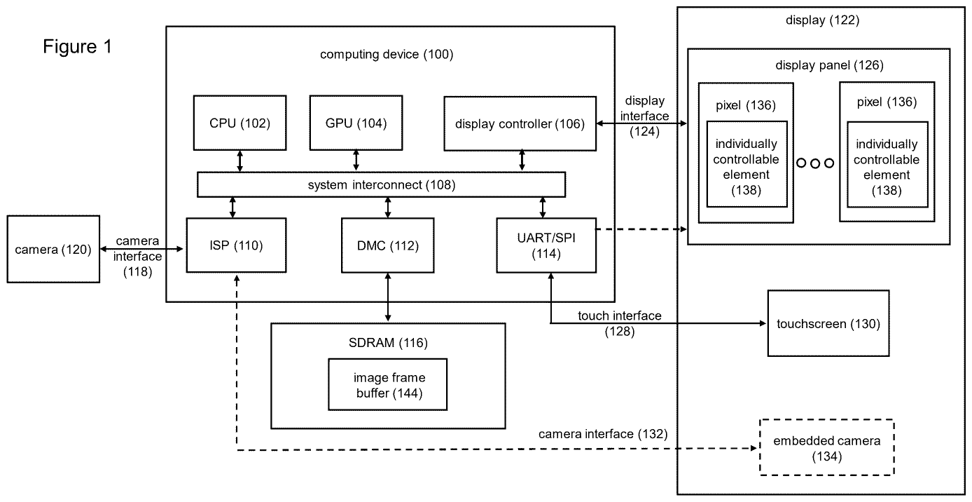

FIG. 1 is a diagram of a computing device 100, consistent with an example embodiment. Computing device 100 includes a central processing unit (CPU) 102, a graphics processing unit (GPU) 104, a display controller 106, an image signal processor (ISP) 110, a dynamic memory controller (DMC) 112 coupled to synchronous dynamic RAM (SDRAM) 116, which may define an image frame buffer 144, and a universal asynchronous receiver-transmitter/serial peripheral interface (UART/SPI) 114. A camera 120 is coupled to the ISP 110 via camera interface 118.

In an example embodiment, display controller 106 may provide control signals to control operation of display device 122 having a display panel 126 and a screen, such as touchscreen 130, where the display panel features one or more pixels 136, which may comprise individually controllable emissive elements (ICEEs) 138. In a particular implementation in which ICEEs 138 comprise PeLEDs, for example. In some embodiments, ICEEs 138 of pixels 136 may operate as light sensors, light emitters, and/or light collectors. In this context, an “individually controllable emissive elements (ICEEs)”, as referred to herein, means an electronic component in a display device among multiple ICEEs in the display device that is controllable to emit light independently of other ICEEs in the display device.

In an example embodiment, display device 122 may be coupled to computing device 100 through display interface 124. Display device 122 optionally may include an embedded camera 134 with an optional camera interface 132 to computing device 100.

In example embodiments described herein, computing device 100 may determine whether a portion of display panel 126 of display device 122 is obscured from view by a user/viewer. Such an obfuscation may be determined and/or detected using touchscreen 130 and/or a front-facing camera (e.g., implemented by camera 120, embedded camera 134 and/or ICEEs in display panel 126 configured as light sensors), for example. In a particular implementation, such a front-facing camera may detect a presence of multiple viewers, and computing device 100 may determine portions of display panel 126 that are obscured for all of the detected viewers.

Once such obscured portions determined, computing device 100 may, in an example embodiment, disable or reduce power to one or more ICEEs 138 of one or more pixels 136 of display panel 126, throttle a resolution of display panel 126, and/or configure one or more emissive elements 138 as light collectors/light sensors to harvest energy from ambient light.

In particular embodiments, display device 122 may be implemented as part of a smart phone, smart watch, tablet, or laptop computer, just to provide a few examples. In one implementation, display panel 126 may be configured to display visual media, such as text and images. As used herein, a screen, such as touchscreen 130, may comprise a physical surface of display device 122, and may be formed from glass or plastic, for example.

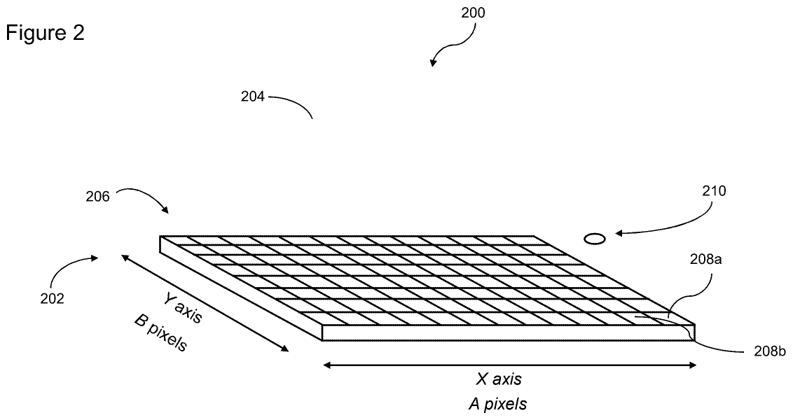

According to an embodiment, display device 122 may be implemented, at least in part, according to features of display device 200 shown in FIG. 2. Display device 200 may comprise display panel 202 having pixel array 206, with individual pixels 208a and 208b indicated (collectively, “pixels 208”), screen 204 (e.g., responsive to pressure/physical touch), and camera 210, to provide an embedded camera. Screen 204, which is disposed over display panel 202, may be made of plastic, glass, or other transparent material, and may comprise coatings to provide protection, reduce glare, resist scratching, and so on. While in proximity to display panel 202, for clarity, screen 204 is shown hovering above display panel. In this example, a pixel array 206 is shown as forming a rectangle of A×B pixels. Pixel resolutions of 1280×720 pixels (HD) or 1920×1080 (Full HD) may be found in some smartphones, for example, while the Iphone 14 has a display resolution of 2532×1170 and the Samsung Galaxy S23 Ultra has a pixel resolution of 3088×1440. The example embodiment of FIG. 2 may represent a small portion of a display.

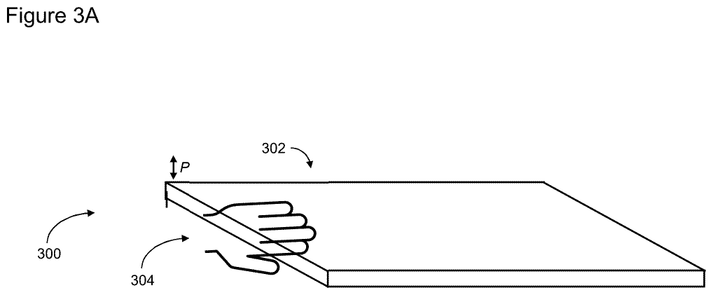

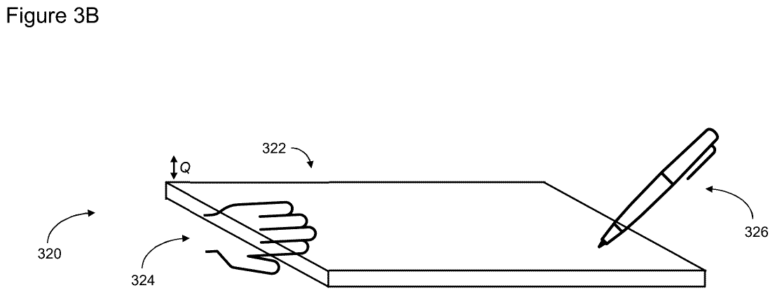

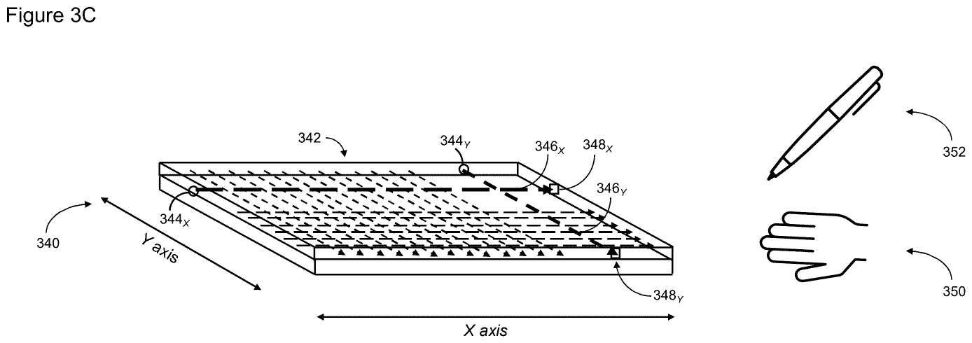

As pointed out above, any one of multiple different techniques may be used to determine portions of a display that are obscured from view by a user/viewer. In a particular implementation, computing device 100 may employ touchscreen technology to determine portions of display panel 126 that are obscured. FIGS. 3A-3C show non-limiting examples of touch sensor type display panels that may be used to determine obscured portions. Display panel 300 (FIG. 3A) comprises a capacitive touchscreen 302, display panel 320 (FIG. 3B) comprises a resistive touchscreen 322, and display panel 340 (FIG. 3C) comprises an infrared touchscreen 342. It should be understood that these are merely example implementations of a touchscreen that may be integrated with a computing device, and that claimed subject matter is not limited in this respect.

In FIG. 3A, touchscreen 302 may detect touch caused by changes in an electric field caused by conductive properties of a human body, thus enabling display panel 300 to detect the presence of the human body on or near the touchscreen. Capacitive touchscreen 302 may, in an example embodiment, have a layer of conductive material disposed beneath a transparent surface layer. Such conductive material may comprise indium tin oxide, as one non-limiting example. Capacitance in the human body, such as the finger or hand of a user (a hand 304 is shown in FIG. 3A for simplicity, but any part of the human body may be detectable by the capacitive touchscreen 302), may cause a disturbance in the electric field of the touchscreen 302. For example, capacitance may be detected if the hand 304 is within a range of P distance from touchscreen 302, where P may vary depending on multiple factors.

In FIG. 3B, touchscreen 322 may detect touch through physical pressure of the screen. Resistive touchscreen 302 may, for example, feature two flexible, conductive layers with spacers disposed therebetween to prevent the layers from touching one another. In response to contact being made with the touchscreen 322, such as by a user, pressure from the touch may cause contact to form between the two layers, which, in turn results in a closed circuit at the point of contact. Resistive touchscreen 302 does not rely on the capacitance of the human body. Thus, while it may detect a hand 324, touchscreen 322 may also be capable of detecting a pointing device, such as a stylus 326, to sense touch, for example.

As shown in FIG. 3C, infrared touchscreen 342, comprises one or more infrared (IR) emitters 344, for producing one or more IR light beams 346, and one or more IR sensors 348 (also known as photodetectors). The IR sensors 348 may sense a change in IR light beams 346, such as when the screen is touched. Two IR emitters 344 are indicated symbolically as “circles”. IR emitter 344X may emit IR light beam 346X along X axis and IR emitter 344Y may emit IR light beam 346Y along Y axis. Infrared touchscreen 342 is capable of detecting touch by a human, such as hand 350, as well as touch from a device, such as stylus 352. IR sensors 348X, and 348Y are indicated symbolically as “squares”. IR sensor 348X may detect an interruption in IR light beam 346X, such as when hand 350 or stylus 352 contacts touchscreen 342 in the path of IR light beam 346X. The example embodiment of FIGS. 3A-3C may represent a small portion of respective touchscreens.

In example embodiments, computing device 100 may communicate with touchscreen 130, such as a touchscreen implemented as any of touchscreens 302, 322, and 342, via touch interface, such as touch interface 128 (FIG. 1), to enable determination of portions of display panel 126 that are obscured from a viewers field of view, and thereafter perform one or more power saving operations, as described further below.

As pointed out above in reference to FIG. 1, pixels 136 of display panel 126 may be formed from ICEEs 138. In one implementation, operation of an ICEE 138 may be controlled such that it is in an “on” state to emit light and an “off” state to not emit light (so as to be dark). In one example, while an ICEE 138 is in such an “on” state, the ICEE may emit at any one of multiple levels of intensity. In a particular implementation of an ICEE 138 as a PeLED, the ICEE 138 may be selectively configured to operate as a light emitter, light sensor or light collector (e.g., one or more of light sensor, light emitter, light collector, optical sensor, and infrared sensor. According to an embodiment, an ICEE 138 implemented as a PeLED device may comprise a layer of perovskite material sandwiched between material formed as an electron transport layer (ETL) and material formed as a hole transport layer (HTL). Such a PeLED device may have features of a PeLED device shown in Bao et al., “A Multifunctional Display Based on Photo-Responsive Perovskite Light-Emitting Diodes,” Nature Electronics, vol. 7, May 2024, pp. 375-382 (herein after “Bao et al.”). In a particular implementation, an electrode of indium tin oxide (ITO) may be attached to the ETL while an electrode of gold (Au) may be attached to the HTL. According to an embodiment, the PeLED may be selectively configured to operate as light emitting device, an energy collecting device (e.g., for converting ambient light into stored energy) or a light sensing device at least in part by controlling a bias voltage between the ITO and Au electrodes.

According to an embodiment, how individual PeLEDs in display panel 126 are to be selected for configuration as a light emitting device, an energy collecting device or a light sensing device may be determined by processes executing at CPU 102. In one implementation, a PeLED in display panel 126 may be selectively configured to operate as a light emitting device, an energy collecting device or a light sensing device from a control signal from UART/SPI 114 over a serial connection. In another implementation, PeLED in display panel 126 may be selectively configured to operate as a light emitting device, an energy collecting device or a light sensing device from a control signal from display controller 106 over a serial connection. For example, if a control signal from display controller 106 over display interface 124 specifies a “0” intensity value for a particular PeLED, that particular PeLED may be configured as an energy collecting device.

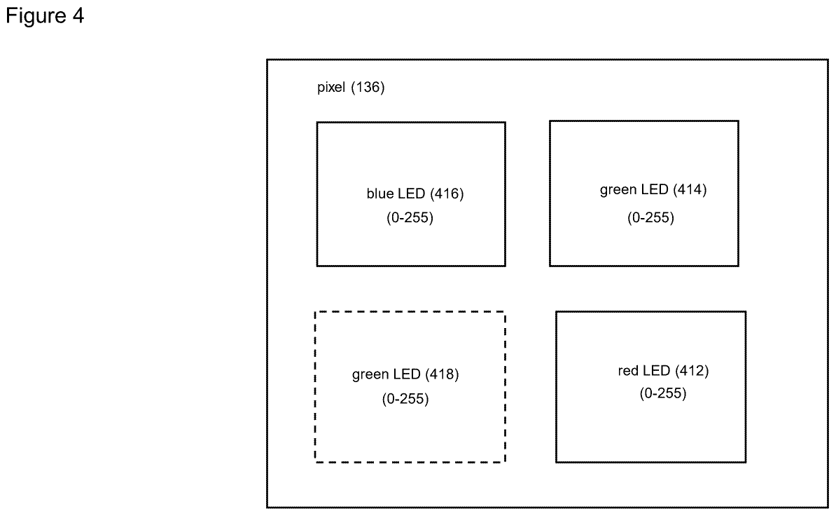

FIG. 4 is a schematic diagram of an implementation of a pixel 136 in a display panel, according to an embodiment. As shown, pixel 136 may comprise four sub-pixels 412, 414, 416 and 418, each sub-pixel being configured to emit light in a particular color. In this particular embodiment, sub-pixels 412, 414, 416 and 418 are arranged in an RGB Bayer pattern. It should be understood, however, that this is merely one example of how different colored sub-pixels may be arranged in a pattern for implementing a display pixel, and claimed subject matter is not limited in this respect. In a particular implementation, each of sub-pixels 412, 414, 416 and 418 may be implemented as an ICEE (e.g., ICEE 138) using an LED device such as an OLED or PeLED. In the particular implementation of pixel 136 using PeLED devices, sub-pixels 412, 414, 416 and 418 may be configured to emit red, blue or green light using different perovskite precursor solutions in manufacturing as described in Bao et al.

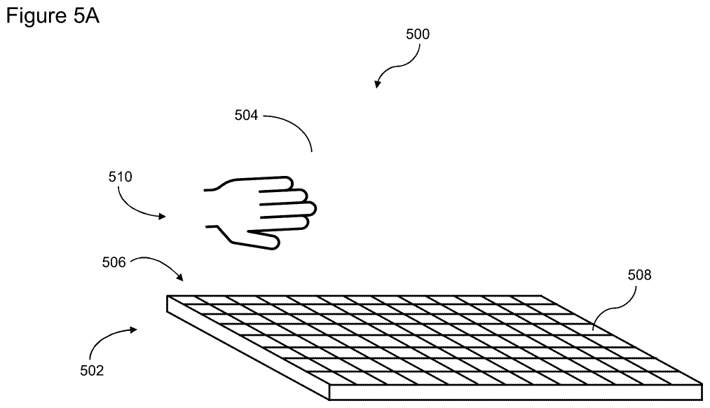

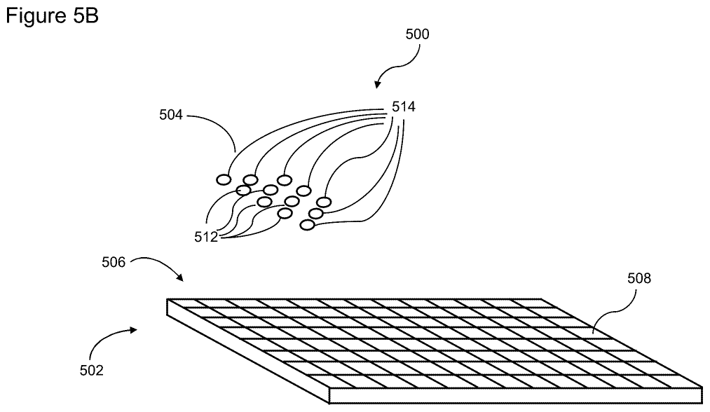

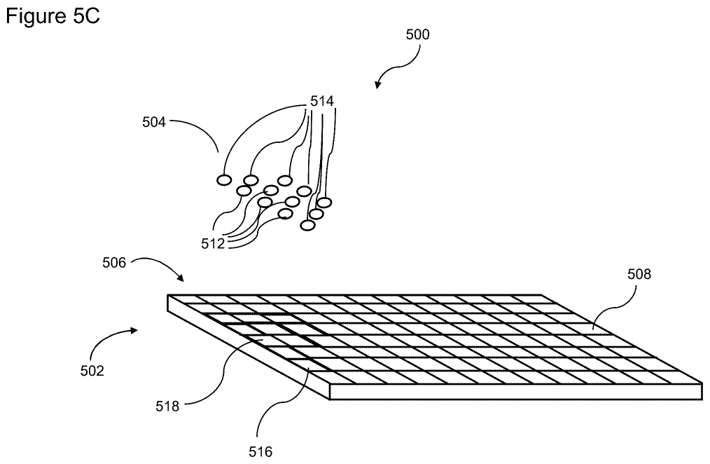

FIGS. 5A-5C illustrate an example embodiment in which computing device 100 may utilize a touchscreen to determine obscured portions of a display panel and subsequently selectively configure one or more ICEEs to provide a power savings. Display 500 comprises screen 504 disposed over display panel 502, with display panel having pixel array 506, with pixel 508 indicated. In an example embodiment, screen 504 may comprise, but not be limited to, a touchscreen such as capacitive touchscreen (e.g., touchscreen 302 of FIG. 3A), resistive touchscreen (e.g., touchscreen 322 of FIG. 3B), or infrared touchscreen (e.g., touchscreen 342 of FIG. 3C). For simplicity, a hand 510 is shown in FIG. 5A as an obscuring object, though it should be understood that a finger, other part of a user's body or inanimate object (e.g., pen) may likewise be an obscuring object. It should be understood, however, that there may be other objects that may obscure portions of a display, and claimed subject matter is not limited in this respect.

As shown in FIG. 5B, touch points 512 and 514 may indicate where the hand 510 contacts (or is within a range of) screen 504. Touch points 512 are those which fully obscure pixels 508 of pixel array 506 while touch points 514 are those which on periphery of contact may only partially obscure pixels 508. Touch points 514 are adjacent to and, in this example, surround touch points 512. In an example embodiment, hand 510 fully and partially blocking one or more pixels may be from the point of view of a user viewing screen 504 of display panel 500.

In an example embodiment, computing device 100 may employ a touch sensitivity of screen 504 to determine which pixels 508 are obscured. In FIGS. 5B and 5C, touch points 512 and 514 corresponding to points of contact/pressure of hand 510 on screen 504. Here, touch points 512 may comprise points that are central to an area of contact with screen 504 while touch points 514 may comprise points that are peripheral to the area of contact with screen 504. In an example embodiment, computing device 100 may determine that pixels corresponding to/underneath touch points 512 (central to an area of contact) are completely obscured while touch points 514 (peripheral to the area of contact) are partially obscured. In one particular implementation, ICEEs in display panel 502 corresponding to touch points 512 may be switched off so as to not emit light (e.g., operating at minimum power or power off). In one implementation, ICEEs in display panel 502 corresponding to touch points 512 may also be switched off. In another implementation, power usage of ICEEs in display panel 502 corresponding to touch points 512 may be reduced by operating according to reduced image resolution (e.g., where some of the ICEEs in display panel 502 are selected to emit while other ICEEs in display panel 502 are selected to not emit).

In example embodiments, display panel 502 may be formed as a “stacked” display panel in which ICEEs are formed in multiple layers in a stacked arrangement. Here, a viewer of such a stacked display may view an image formed from a combination and/or superposition of light emitted by ICEEs formed on multiple different stacked layers. In one embodiment of such a stacked arrangement, each of multiple layers includes ICEEs formed in a multicolor pattern (e.g., an RGB Bayer pattern). In another embodiment of such a stacked arrangement, a first layer of ICEEs may form a first pixel array for emitting light of a first color (e.g., red), a second layer of ICEEs may form a second pixel array for emitting light of a second color (e.g., green) and a third layer of ICEEs may form a third pixel array for emitting light of a third color (e.g., blue).

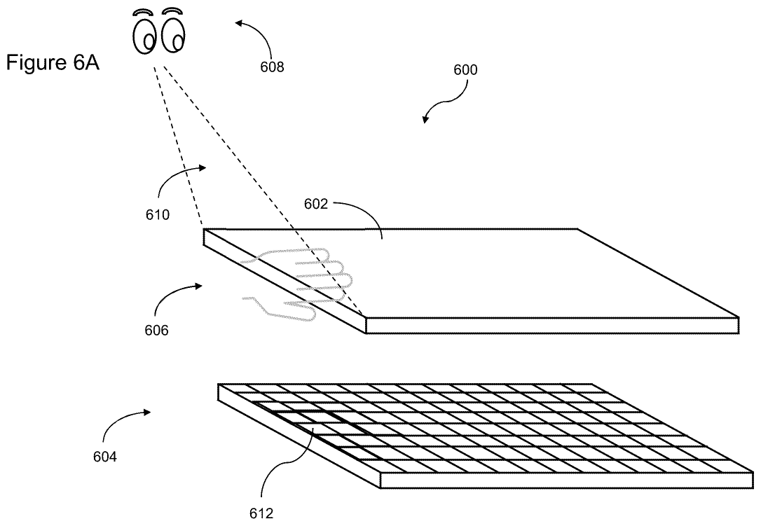

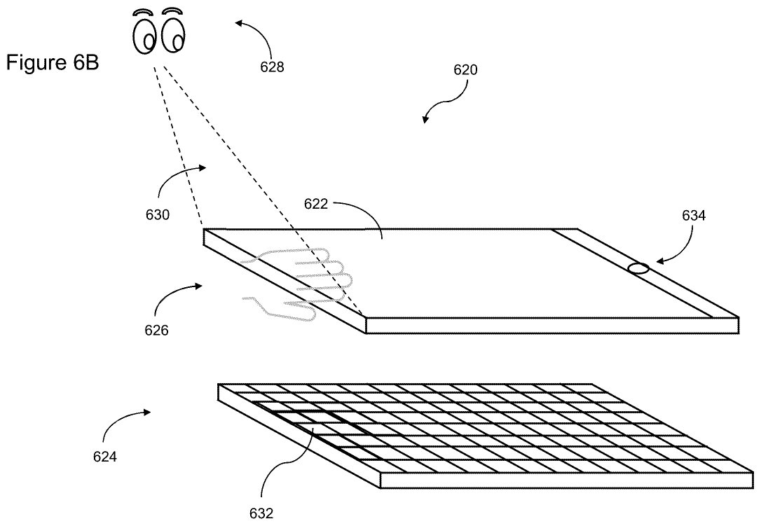

As shown in FIGS. 6A and 6B, portions of pixel array 604 obscured from view by a viewer 608 may be determined using any one of multiple different techniques (individually and/or in combination). As shown in FIG. 6A, display panel 600 comprises touchscreen 602 and pixel array 604. In one embodiment, pixel array 604 may comprise ICEEs selectively configurable as a light sensor (e.g., PeLED). In exemplary embodiments, to determine portions of screen 602 about which power consumption may be reduced, computing device 100 may employ any one of multiple different techniques. In one technique, pressure by hand 606 upon touchscreen 602, such as using a mechanism as described in FIGS. 3A-3C and 5A-5C, may be used to determine obscured portions of screen 602. In another technique, visual field 610 of viewer 608, may be used to identify portions of screen 602 that are not of particular focus by a viewer (e.g., attention of eyes/pupils is are directed to other portions of screen 602). Based on the portions of screen 602 determined to be obscured, computing device 100 may partially or fully remove power to ICEEs, resulting in associated pixels in pixel array 604 being partially or fully powered off. Because visual field 610 of viewer 608 is over hand 606, pixels directly beneath hand 606 may be regarded as being obscured. As such, computing device 100, in some embodiments, may remove power from ICEEs associated with those obscured pixels.

In one embodiment, for portions of screen 602 that are obscured (whether by touch or cover), computing device 100 may affect an image output for associated ICEEs beneath those portions of the screen. On a boundary region, or for a region where the obfuscation is less certain, ICEEs may be at a lower intensity and/or lower resolution. In one implementation, a rendering unit of GPU 104 (or video processing unit (VPU), not shown) may be inhibited from rendering such areas on such a boundary region. Additionally, display controller 106 may be inhibited from fetching these regions from memory, and instead output “0” for such regions. In example embodiments, this may result in reduced power consumption from not only by display panel 600, but also potentially reduced power consumption by display controller 106, DMC 112, SDRAM 144 and/or VPU/GPU 104, without a significantly diminished visual quality or viewer experience for those portions of the display which are not affected.

According to an embodiment, display interface 124 may support and/or employ data compression. Such data compression may enable display interface 124 to transmit controls signals (for presentation of an image) to display panel 126 even if control signals generated by display controller 106 exceeds bandwidth of display interface 124. Compression implanted at display interface 124 may also reduce an amount of energy used transfer the control signals from display controller 106 to display panel 126 while minimally affecting image quality. In one example, display interface 124 may employ a lossy compression such as display stream compression (DSC), which may implement a rate controller (not shown) to control an amount of bandwidth used to compress control signals for each pixel. In one implementation, an indication that a portion of the display is not visible by a viewer (i.e., obscured) may permit the rate controller to reallocate bandwidth for control signals for pixels in the obscured portion to control signals for pixels that are visible. This may increase/enhance a visual quality (reducing the amount of compression), of the portion that is visible by the viewer.

As pointed out above according to certain embodiments, detection of certain conditions may provide opportunities for reducing power to ICEEs in a display device without significantly impacting image quality and/or user experience. Such opportunities may arise, for example, if: 1) certain portions of the display device are obscured from view; or 2) certain portions are not being viewed with particular focus by a viewer. Responsive to detection of these conditions, according to embodiment, computing device 100 may reduce power to ICEEs in affected portions of a display panel (e.g., display panel 502 shown in FIG. 5A, 5B or 5C, or display panel 600 shown in FIGS. 6A and 6B) using any one of several techniques. In one example, ICEEs in obscured portions of a display device may be switched off so as to not draw power to emit. For ICEEs implemented as PeLEDs, such ICEEs in obscured portions of a display device may be further configured to collect ambient light as stored energy or to act as light sensors (e.g., as part of a front-facing camera).

In other embodiments, responsive to detection of certain conditions, power consumed by ICEEs of the display device may be reduced at least in part by reducing an effective resolution of the display device. According to an embodiment, computing device 100 may reduce a resolution of at least a portion of an image presented on a display device responsive to a determination that a viewer is at least a particular minimum distance from the display device (e.g., by processing signals from a front-facing camera). In another embodiment, computing device 100 may reduce a resolution on at least a portion of a presented image based on a determination of a visual acuity of a viewer. In one example scenario, computing device 100 may be configured to present content on display panel 126 according to a visual acuity of a particular viewer. In one scenario, based on signals processed from a front-facing camera computing device 100 may determine that the particular viewer has a diminished visual acuity if the viewer normally wears corrective eye lens and is not currently wearing spectacles. In another example scenario, computing device 100 may detect multiple viewers, and present content on display panel 126 according to a viewer having the best visual acuity. In another embodiment, computing device 100 may reduce a resolution on a particular portion of a presented image if signals processed from a front-facing camera indicate that a viewer is focusing attention on a different portion of the presented image. In one embodiment, computing device 100 may comprise capabilities of identifying a viewer such as by facial recognition (e.g., based on signals from a front-facing camera) or other techniques for identifying a viewer. Here, computing device 100 may additionally access information (e.g., in a database) indicating a visual acuity for identified individuals.

According to embodiment, computing device 100 may reduce power consumed by a display device by selectively removing power from ICEEs in the display device to effectively reduce a resolution of a presented image. In one example embodiment, for every Nth pixel of a presented image, power may be removed from one or more ICEEs corresponding to the Nth pixel. In another example, embodiment, for pixels formed from for ICEEs with two green ICEEs, one blue ICEE and one red ICEE (e.g., as shown in FIG. 4), one of the green ICEEs may be configured to not emit (and reduce power) while the other three ICEEs may be configured to emit. In yet another example implementation, an appropriate pattern may be chosen to selectively configure some ICEEs to emit and other ICEEs to not emit over a number of pixels.

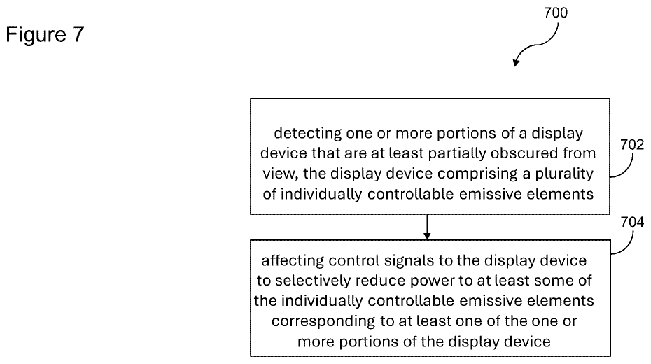

FIG. 7 is a flow diagram of operations that may be performed, at least in part, by the computing device 100, according to example embodiments. As pointed out above, computing device 100 may monitor a portion of a display device, such as a screen of a display panel. A touch point of a touchscreen may indicate that a hand, stylus, or other device is blocking a portion of a display panel from view. A visual field of a viewer of the display device may be detected, whether by a front-facing camera (e.g., camera external to the display device, an embedded camera, and/or ICEEs in display device configured as light sensors).

According to an embodiment, a process shown in FIG. 7 may reduce power to at least some ICEEs in a display panel corresponding to portions that are obscured from view. Block 702 may comprise detecting portions of a display device that are at least partially obscured to a viewer using any one of several techniques such as, for example, techniques discussed herein. Block 704 may comprise affecting control signals to the display device (e.g., signals from a display controller) to selectively reduce power to at least some individually controllable emissive elements in the display device. In one implementation, for example, power may be reduced to individually controllable emissive elements at block 704 by completely powering off the ICEEs (e.g., ICEE intensity level specified as “0” to display black). In another implementation in which ICEEs in the display device comprise PeLEDs, for example, block 704 may comprise reconfiguring the ICEEs to function as light sensor and/or device for converting ambient light into stored energy.

Block 702 in one implementation may detect portions of a display device that are at least partially obscured based, at least in part, processing signals from a touchscreen to determine touch points (e.g., as shown in FIGS. 5A, 5B and 5C). In another implementation, block 702 may detect portions of a display device that are at least partially obscured based, at least in part, processing signals from a front-facing camera to detect of one or more objects in a line of sight of a viewer between the viewer and the display device. Here, such objects in a line of sight of a viewer between the viewer and the display device may be detected based, at least in part, on processing signals from an embedded camera (e.g., embedded camera 634 or 676) or signals from PeLEDs in the display device configured as light sensors. For example, PeLEDs in a display device may be configured to accumulate signal energy responsive to ambient light; and one or more portions of the display device that are at least partially obscured from view may be detected from processing signal energy accumulated by such PeLEDs.

In another embodiment, block 702 may combine identified touch points (e.g., from processing signals from a touchscreen) and one or more detected objects in a line-of-sight of one or more viewers to the display device (e.g., from processing signals from a front-facing camera) to determine the one or more portions of the display device that are at least partially obscured from view. In one scenario, multiple individuals at different viewing positions may be viewing an image presented on a display device. In an implementation, block 702 may determine portions of a display device that are obscured from view by the multiple individuals. For example, computing device 100 may process signals from a front-facing camera to 1) detect multiple viewers (e.g., from detection of appropriately spaced pairs of eyes/pupils), 2) detect objects in the line of sight of the multiple viewers to the display device and 3) portions that are the display device that are obscured from view by the multiple viewers because of the detected objects. In yet another implementation, detection of obscured portions may be based solely on detected touch points at a touchscreen responsive to detection of eyes of multiple viewers in the one or more detected one or more features.

In one embodiment, ICEEs in a display device (e.g., display device 122) may be controllable based on control signals received from a display controller (e.g., display controller 106) via a physical communication channel (e.g., display interface 124). In one implementation, affecting control signals to reduce power to at least some ICEEs at block 704 may result in a reduction in bandwidth usage in the physical communication channel that may be reallocated for other functions (e.g., for controlling portions of the display device that are not obscured). In another implementation, block 704 may affect control signals to reduce power to ICEEs by reducing an image intensity of powered emissive elements corresponding to portions of the display device bordering one or more obscured portions.

In another embodiment, control signals to ICEEs in a display device may be based, at least in part, on one or more images rendered at a GPU (e.g., GPU 104) and/or video processor (not shown). In a particular implementation, block 704 may comprise affecting operation of the GPU and/or video processor based, at least in part, on at least one of the one or more portions of the display device detected at block 702. For example, operation of the GPU and/or video processor may be affected by inhibiting the GPU from rendering image signal intensity values corresponding to pixels of the at least one of the one or more portions of the display device detected at block 702, thereby further reducing power consumption.

In another embodiment, control signals to ICEEs in a display device may be based, at least in part, on image signal intensity values stored in a frame buffer (e.g., frame buffer 144) by a GPU, and fetched by a composition controller (e.g., which may comprise a GPU) and/or display controller (e.g., display controller 106). In one particular implementation, block 704 may comprise inhibiting fetching, by such a composition controller and/or display controller, of at least some of the image signal intensity value stored in the frame buffer corresponding to at least one of the one or more detected portions. In another particular implementation, block 704 may comprise a reduction in a quantity of image signal intensity values to be retrieved from an image frame buffer. Here, a number of image signal intensity values to be retrieved from an image frame buffer (e.g., for pixel locations of an obscured portion) may be reduced.

In another particular implementation, block 702 may comprise processing signals generated by a front-facing camera to track eye movement of a viewer/user. Here, block 704 may further comprise reducing power to ICEEs by affecting a resolution in at least one portion of the display device based, at least in part, on the tracked eye movement of the viewer. For example, block 704 may reduce resolution in portions that are not of particular focus by a viewer (e.g., eyes detected looking elsewhere on display device).

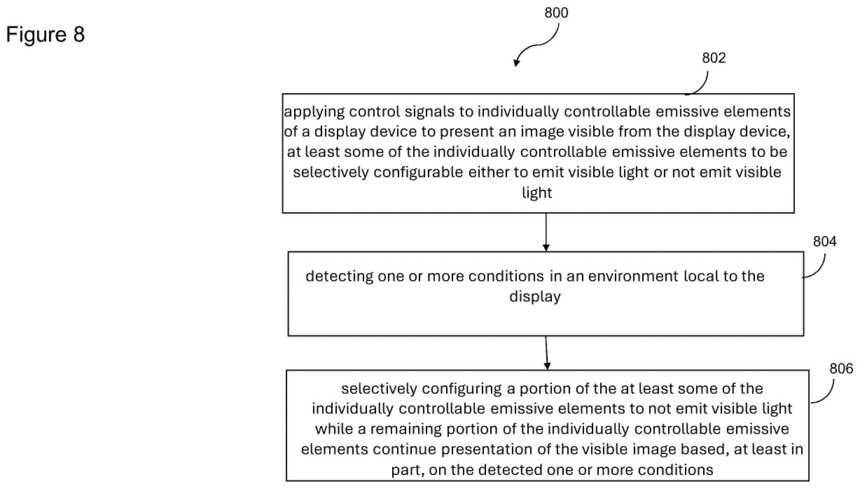

According to an embodiment, computing device 100 may execute a process shown in FIG. 8 to selectively configure a portion of ICEEs in a display device to not emit visible light based, at least in part, on one or more detected conditions. Block 802 may comprise, for example, application of control signals (e.g., from display controller 106) to ICEEs of a display device (e.g., display device 122) to present an image visible from the display device. Here, at least some of the ICEEs to be selectively configurable either to emit visible light or not emit visible light. For example, the individually controllable emissive elements may comprise LEDs such as OLEDs or PeLEDs, just to provide a few examples. Block 804 may comprise, for example, detection of one or more conditions in an environment local to the display device. Based, at least in part, on the one or more detected conditions, block 806 may selectively configure a portion of the at least some of the ICEEs to not emit visible light while a remaining portion of the ICEEs continue presentation of the visible image. In the particular implementation of PeLEDs as ICEEs in the display device, block 806 may comprise selectively configuring ICEEs to either emit visible light or to convert ambient light to stored energy.

According to an embodiment, block 804 may comprise reconfiguring a portion of the at least some ICEEs to emit visible light responsive to detection of user activity local to a computing device (e.g., computing device 100). In one particular implementation, block 804 may detect such user activity local to a computing device as user input (e.g., via a pointing device, selection on a touch screen, voice command, etc.), movement of the user or device movement detected by an accelerometer (e.g., built-in to the computing device), or a combination thereof.

In another embodiment, block 804 may comprise detecting an absence of a user's attention over image pixels in the visible image corresponding to the portion of the at least some of the ICEEs. For example, a user's eyes may be tracked based on signals from a front-facing camera to determine which portions (e.g., pixels) are receiving the most attention of the user and which portions are receiving the least attention of the user. For portions that are receiving the least attention of the user, block 806 may configure at least some of the corresponding individually controllable emissive elements to not emit visible light.

In another embodiment, block 804 may comprise processing signals to measure a distance and/or orientation of a viewer with respect to the display (e.g., processing signals from a front-facing camera). Additionally, block 804 may further comprise processing signals from sensors and/or front-facing camera to detect/measure brightness of ambient light. Here, block 806 may then include selectively configuring ICEEs to not emit visible light while a remaining portion of the ICEEs continue presentation of the visible image further based, at least in part, on detected one or more parameters indicative of a visual acuity of a viewer of the display relative to the visual acuity of the user. In one particular implementation, the visual acuity of a viewer may be assessed/detected based, at least in part, on processed signals from a front-facing camera. For example, processed signals from a front-facing camera may indicate a presence or absence of spectacles being worn by the viewer.

According to an embodiment, control signals applied to ICEEs at block 802 may be generated, at least in part, based on image signal intensity values of an image rendered by a GPU and stored in an image frame buffer. To determine ICEEs that are not to emit visible light, block 804 may comprise reducing an image resolution over at least a portion an image rendered by the GPU. In an implementation, ICEEs for a pixel or sub-pixel could be disabled by outputting “black.” For example, the GPU may generate image signal values in a frame buffer as black for pixels corresponding to ICEEs that may not emit visible light. In this case, display controller may still output the same number of pixels, but with a certain portion (e.g., ¾) being black. For example, the GPU may be commanded to generate an image of ¼ the resolution (to reduce compute), and request the display controller to fetch the ¼ resolution image, and output image signal intensity values for every other pixel.

In one implementation, a portion of ICEEs to not emit visible light may be determined based on one or more control signals from a display controller (e.g., display controller 106) to a display device (e.g., display device 122). These one or more control signals may correspond to black for image pixels corresponding to the ICEEs. In another embodiment wherein a portion of ICEEs to not emit visible light is determined based on one or more control signals from a display controller (and/or from a UART/SPI connection) to a display device, the control signals may configure the at least some of the ICEEs to convert ambient light to stored energy.

In another embodiment, block 804 may comprising measuring a distance and/or orientation of a viewer with respect to the front of the display. Such a distance and/or orientation of a viewer with respect to the front of the display may be measured, for example, using signals from camera 120, embedded camera 134, ICEEs configured as light sensors or depth sensor (e.g., LiDAR sensor) (not shown). Block 806 may then comprise varying a ratio of ICEEs selectively configured to emit visible light to ICEEs configured to not emit visible light based, at least in part, on the distance and/or orientation of the viewer with respect to the front of the display determined at block 804. Additionally, face recognition/face (eye) detection may potentially be performed together with a depth sensor (e.g., LiDAR sensor) and a front-facing camera (e.g., using signals from camera 120, embedded camera 134 and/or ICEEs configured as light sensors).

In another embodiment, ICEEs of a display device (e.g., display device 122) may be configured in a multi-color pixel pattern such as a red, green and blue pixel pattern (e.g., an RGB Bayer pattern). For example, each pixel may be implemented by four ICEEs, one ICEE to emit red light, one ICEE to emit blue light and two ICEEs to emit green light. In one particular implementation, block 806 may comprise configuring a portion of green ICEEs in the pattern to not emit visible light, while red ICEEs and blue ICEEs are configured to emit visible light for presentation of the visual image. As pointed above, selected ICEEs forming pixels in a display may be configured to not emit light in a particular pattern over a determined number of the formed pixels. In another particular implementation, block 806 may comprise configuring selected ICEEs to not emit visible light according to a modification of the repeated multi-color pixel pattern in pixels over a portion of the visible image.

In another embodiment, block 806 may comprise selectively configuring ICEEs to not emit visible light while a remaining portion of the ICEEs to continue presentation of the visible image further based, at least in part, on a brightness setting of a display device. In another embodiment, block 806 may comprise configuring ICEEs by reducing a resolution of the presented image. Such a resolution may be reduced, for example, using techniques as discussed herein.

Aspects of computing device 100 (FIG. 1) and other devices described herein in particular examples, may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Computing devices such as those shown in FIG. 1 may comprise, for example, a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1, 7, and 8, and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted that an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

Some embodiments may be described, at least in part, by the following numbered clauses or by any combination thereof:
Clause 1: A method comprising:
   detecting one or more portions of a display device that are at least partially obscured from view, the display device comprising a plurality of individually controllable emissive elements; and
   affecting control signals to the display device to selectively reduce power to at least some of the individually controllable emissive elements corresponding to at least one of the one or more portions of the display device.
Clause 2: The method of clause 1, wherein the affected control signals are to power off the at least some of the individually controllable emissive elements corresponding to the at least one of the one or more portions of the display device.
Clause 3: The method of clause 1, wherein the affected control signals are to reduce an image intensity corresponding to the at least one of the one or more portions of the display device.
Clause 4: The method of any of clauses 1-3, wherein the individually controllable emissive elements comprise light emitting diodes (LEDs).
Clause 5: The method of any of clauses 1-4, wherein detecting one or more portions of the display device that are at least partially obscured from view comprises processing signals from a touchscreen positioned over the display device.
Clause 6: The method of clauses 1-4, wherein detecting one or more portions of the display device that are at least partially obscured from view comprises:
   processing signals from a touchscreen positioned over the display device to identify one or more touch points;
   processing signals from a front-facing camera to detect one or more objects in a line-of-sight of one or more viewers to the display device; and
   combining the identified one or more touch points and the detected one or more objects to determine the one or more portions of the display device that are at least partially obscured from view.
Clause 7: The method of clause 6, wherein:
   the detected one or more objects comprise eyes of multiple viewers; and
   the one or more portions of the display device to include portions of the display device that are not viewable by each of the multiple viewers.
Clause 8: The method of clause 6, wherein:
   the method further comprises determining one or more portions of the display device that are at least partially obscured from view solely based on the identified one or more touch points responsive to detection of eyes of multiple viewers.
Clause 9: The method of any of clauses 1-8, wherein:
   at least some of the individually controllable emissive elements are configurable to accumulate signal energy responsive to ambient light; and
   detecting one or more portions of the display device that are at least partially obscured from view further comprises processing signal energy accumulated by the at least some of the individually controllable emissive elements.
Clause 10: The method of clause 1, wherein detecting the one or more portions of the display device that are at least partially obscured from view further comprises processing signals generated by a front-facing camera.
Clause 11: The method clause 10, wherein the front-facing camera is formed at least in part, from one or more of the plurality of individually controllable emissive elements configured as one or more light sensors.
Clause 12: The method of clause 11, wherein the affected control signals are further to reduce an image intensity to individually controllable emissive elements in the display device bordering the at least one of the one or more portions of the display device.
Clause 13. The method of clause 10, and further comprising:
   processing the signals generated by the front-facing camera to track eye movement of a viewer; and
   affecting a resolution in at least one portion of the display device based, at least in part, on the tracked eye movement of the viewer.
Clause 14: The method of clause 10, and further comprising:
   processing the signals generated by the front-facing camera to detect one or more objects in a line-of-sight from a viewer to the display device; and
   determining the one or more portions of the display device that are at least partially obscured from view based, at least in part, on the detected one or more objects.
Clause 15: The method of any of clauses 1-14, wherein:
   the control signals are transmitted to the display device via a physical communication channel coupled between a display controller and the plurality of individually controllable emissive elements; and
   the method further comprises reallocating bandwidth in the physical communication channel based, at least in part, on the detected one or more portions.
Clause 16: The method of any of clauses 1-15, wherein the control signals are based, at least in part, on one or more images rendered at a graphics processing unit (GPU) or video processing unit (VPU), and the method further comprises affecting operation of the GPU or VPU based, at least in part, on at least one of the detected one or more portions.
Clause 17: The method of any of clauses 1-16, wherein the control signals are based, at least in part, on image signal intensity values stored in an image frame buffer and fetched by a composition controller and/or display controller, and the method further comprises inhibiting fetching, by the composition controller and/or display controller, of at least some of the image signal intensity value stored in the image frame buffer corresponding to at least one of the detected one or more portions.
Clause 18: The method of any of clauses 1-17, and further comprising reducing a quantity of image signal intensity values to be retrieved from an image frame buffer, the image signal intensity values corresponding to at least one of the one or more portions of the display device that are at least partially obscured from view.
Clause 19: A controller device, comprising:
   circuitry to detect one or more portions of a display device that are at least partially obscured from view, the display device comprising a plurality of individually controllable emissive elements; and
   circuitry to affect control signals to the display device to selectively reduce power to at least some of the individually controllable emissive elements corresponding to at least one of the one or more portions of the display device.
Clause 20. The controller device of clause 19, wherein:
   at least some of the individually controllable emissive elements are configurable to accumulate signal energy responsive to ambient light; and
   the circuitry to detect one or more portions of the display device that are at least partially obscured from view further comprises circuitry to process signal energy accumulated by the at least some of the individually controllable emissive elements.
Clause 21: The controller device of clause 19 or 20, wherein the circuitry to detect one or more portions of the display device that are at least partially obscured from view further comprises circuitry to process signals generated by a front-facing camera.
Clause 22: The controller device of clause 21, wherein the front-facing camera is formed at least in part, from one or more of the plurality of individually controllable emissive elements configured as one or more light sensors.
Clause 23: The controller device of clause 22, wherein the affected control signals are further to reduce an image intensity to individually controllable emissive elements in the display device bordering the at least one of the one or more portions of the display device.
Clause 24: The controller device of any of clauses 21-23, and further comprising:
   circuitry to process the signals generated by the front-facing camera to track eye movement of a viewer; and
   circuitry to affect a resolution in at least one portion of the display device based, at least in part, on the tracked eye movement of the viewer.
Clause 25. The controller device of any of clauses 21-24, and further comprising:
   circuitry to process the signals generated by the front-facing camera to detect one or more objects in a line-of-sight from a viewer to the display device; and
   circuitry to determine the one or more portions of the display device that are at least partially obscured from view based, at least in part, on the detected one or more objects.
Clause 26: The controller device of any of clauses 19-25, wherein:
   the control signals are transmitted to the display device via a physical communication channel coupled between a display controller and the plurality of individually controllable emissive elements; and
   further comprising circuitry to reallocate bandwidth in the physical communication channel based, at least in part, on the detected one or more portions.
Clause 27: The controller device of any of clauses 19-26, wherein the control signals are based, at least in part, on one or more images rendered at a graphics processing unit (GPU) or video processing unit (VPU), and further comprising circuitry to affect operation of the GPU or VPU based, at least in part, on at least one of the detected one or more portions.
Clause 28: The controller device of clause 19, wherein the control signals are based, at least in part, on image signal intensity values stored in an image frame buffer and fetched by a composition controller and/or display controller, and further comprising circuitry to inhibit fetching, by the composition controller and/or display controller, of at least some of the image signal intensity value stored in the image frame buffer corresponding to at least one of the detected one or more portions.
Clause 29: The controller device of clause 19, and further comprising circuitry to reduce a quantity of image signal intensity values to be retrieved from an image frame buffer, the image signal intensity values corresponding to at least one of the one or more portions of the display device that are at least partially obscured from view.
Clause 30: The controller device of any of clauses 19-29, wherein the affected control signals are to power off the at least some of the individually controllable emissive elements corresponding to the at least one of the one or more portions of the display device.
Clause 31: The controller device of any of clauses 19-30, wherein the affected control signals are to reduce an image intensity corresponding to the at least one of the one or more portions of the display device.
Clause 32: The controller device of any of clauses 19-31, wherein the individually controllable emissive elements comprise light emitting diodes (LEDs).
Clause 33: The controller device of any of clauses 19-32, wherein circuitry to detect one or more portions of the display device that are at least partially obscured from view comprises circuitry to process signals from a touchscreen positioned over the display device.
Clause 34: The controller device of clauses 19-33, wherein circuitry to detect one or more portions of the display device that are at least partially obscured from view comprises:
   circuitry to process signals from a touchscreen positioned over the display device to identify one or more touch points;
   circuitry to process signals from a front-facing camera to detect one or more objects in a line-of-sight of one or more viewers to the display device; and
   circuitry to combine the identified one or more touch points and the detected one or more objects to determine the one or more portions of the display device that are at least partially obscured from view.
Clause 35: The controller device of clause 34, wherein:
   the detected one or more objects comprise eyes of multiple viewers; and
   the one or more portions of the display device to include portions of the display device that are not viewable by each of the multiple viewers.
Clause 36: The controller device of clause 34, wherein:
   the method further comprises determining one or more portions of the display device that are at least partially obscured from view solely based on the identified one or more touch points responsive to detection of eyes of multiple viewers.
Clause 37: A non-transitory computer-readable medium storing computer-readable code for fabrication of an apparatus comprising:
   circuitry to detect one or more portions of a display device that are at least partially obscured from view, the display device comprising a plurality of individually controllable emissive elements; and
   circuitry to affect control signals to the display device to selectively reduce power to at least some of the individually controllable emissive elements corresponding to at least one of the one or more portions of the display device.
Clause 38: The non-transitory computer-readable medium of clause 37, wherein the affected control signals are to power off the at least some of the individually controllable emissive elements corresponding to the at least one of the one or more portions of the display device.
Clause 39: The non-transitory computer-readable medium of clause 37, wherein the affected control signals are to reduce an image intensity corresponding to the at least one of the one or more portions of the display device.
Clause 40: The non-transitory computer-readable medium of any of clauses 37-39, wherein the individually controllable emissive elements comprise light emitting diodes (LEDs).
Clause 41: The non-transitory computer-readable medium of any of clauses 37-40, wherein the circuitry to detect one or more portions of the display device that are at least partially obscured from view comprises circuitry to process signals from a touchscreen positioned over the display device.
Clause 42: The non-transitory computer-readable medium of any of clauses 37-40, wherein the circuitry to detect one or more portions of the display device that are at least partially obscured from view comprises:
   circuitry to process signals from a touchscreen positioned over the display device to identify one or more touch points;
   circuitry to process signals from a front-facing camera to detect one or more objects in a line-of-sight of one or more viewers to the display device; and
   circuitry to combine the identified one or more touch points and the detected one or more objects to determine the one or more portions of the display device that are at least partially obscured from view.
Clause 43: The non-transitory computer-readable medium of clause 42, wherein:
   the detected one or more objects comprise eyes of multiple viewers; and
   the one or more portions of the display device to include portions of the display device that are not viewable by each of the multiple viewers.
Clause 44: The non-transitory computer-readable medium of clause 42, wherein:
   the apparatus further comprises circuitry to determine one or more portions of the display device that are at least partially obscured from view solely based on the identified one or more touch points responsive to detection of eyes of multiple viewers.
Clause 45: The non-transitory computer-readable medium of any of clauses 37-44, wherein:
   at least some of the individually controllable emissive elements are configurable to accumulate signal energy responsive to ambient light; and
   the circuitry to detect one or more portions of the display device that are at least partially obscured from view further comprises circuitry to process signal energy accumulated by the at least some of the individually controllable emissive elements.
Clause 46: The non-transitory computer-readable medium of clause 37, wherein the circuitry to detect the one or more portions of the display device that are at least partially obscured from view further comprises circuitry to process signals generated by a front-facing camera.
Clause 47: The non-transitory computer-readable medium clause 46, wherein the front-facing camera is formed at least in part, from one or more of the plurality of individually controllable emissive elements configured as one or more light sensors.
Clause 48: The non-transitory computer-readable medium of clause 47, wherein the affected control signals are further to reduce an image intensity to individually controllable emissive elements in the display device bordering the at least one of the one or more portions of the display device.
Clause 49: The non-transitory computer-readable medium of clause 46, wherein the apparatus further comprises:
   circuitry to process the signals generated by the front-facing camera to track eye movement of a viewer; and
   circuitry to affect a resolution in at least one portion of the display device based, at least in part, on the tracked eye movement of the viewer.
Clause 50: The non-transitory computer-readable medium of clause 46, wherein the apparatus further comprises:
   circuitry to process the signals generated by the front-facing camera to detect one or more objects in a line-of-sight from a viewer to the display device; and
   circuitry to determine the one or more portions of the display device that are at least partially obscured from view based, at least in part, on the detected one or more objects.
Clause 51: The non-transitory computer-readable medium of any of clauses 37-50, wherein:
   the control signals are transmitted to the display device via a physical communication channel coupled between a display controller and the plurality of individually controllable emissive elements; and
   the apparatus further comprises circuitry to reallocate bandwidth in the physical communication channel based, at least in part, on the detected one or more portions.
Clause 52: The non-transitory computer-readable medium of any of clauses 37-51, wherein the control signals are based, at least in part, on one or more images rendered at a graphics processing unit (GPU) or video processing unit (VPU), and the apparatus further comprises circuitry to affect operation of the GPU or VPU based, at least in part, on at least one of the detected one or more portions.
Clause 53: The non-transitory computer-readable medium of any of clauses 37-52, wherein the control signals are based, at least in part, on image signal intensity values stored in an image frame buffer and fetched by a composition controller and/or display controller, and the apparatus further comprises circuitry to inhibit fetching, by the composition controller and/or display controller, of at least some of the image signal intensity value stored in the image frame buffer corresponding to at least one of the detected one or more portions.
Clause 54: The non-transitory computer-readable medium of any of clauses 37-53, wherein the apparatus further comprises circuitry to reduce a quantity of image signal intensity values to be retrieved from an image frame buffer, the image signal intensity values corresponding to at least one of the one or more portions of the display device that are at least partially obscured from view.

1. A method comprising:
detecting one or more portions of a display device that are at least partially obscured from view, the display device comprising a plurality of individually controllable emissive elements, wherein detecting one or more portions of the display device that are at least partially obscured from view comprises processing signals from an image capture device to detect one or more objects in a line-of-sight of one or more viewers between the one or more viewers and the display device; and
affecting control signals to the display device to selectively reduce power to at least some of the individually controllable emissive elements corresponding to at least one of the one or more portions of the display device.

2. The method of claim 1, wherein the affected control signals are to power off the at least some of the individually controllable emissive elements corresponding to the at least one of the one or more portions of the display device.

3. The method of claim 1, wherein the affected control signals are to reduce an image intensity corresponding to the at least one of the one or more portions of the display device.

4. The method of claim 1, wherein the individually controllable emissive elements comprise light emitting diodes (LEDs).

5. The method of claim 1, wherein detecting one or more portions of the display device that are at least partially obscured from view comprises processing signals from a touchscreen positioned over the display device.

6. The method of claim 1, wherein detecting one or more portions of the display device that are at least partially obscured from view further comprises:
processing signals from a touchscreen positioned over the display device to identify one or more touch points; and
combining the identified one or more touch points and the detected one or more objects to determine the one or more portions of the display device that are at least partially obscured from view.

7. The method of claim 6, wherein:
the one or more portions of the display device to include portions of the display device that are not viewable by each of multiple viewers.

8. The method of claim 6, wherein:
the method further comprises determining one or more portions of the display device that are at least partially obscured from view solely based on the identified one or more touch points responsive to detection of eyes of multiple viewers.

9. A controller device, comprising:
circuitry to detect one or more portions of a display device that are at least partially obscured from view, the display device comprising a plurality of individually controllable emissive elements, wherein the detection of one or more portions of the display device that are at least partially obscured from view comprises circuitry to process signals from an image capture device to detect one or more objects in a line-of-sight of one or more viewers between the one or more viewers and the display device; and
circuitry to affect control signals to the display device to selectively reduce power to at least some of the individually controllable emissive elements corresponding to at least one of the one or more portions of the display device.

10. The controller device of claim 9, wherein:
at least some of the individually controllable emissive elements are configurable to accumulate signal energy responsive to ambient light; and
the circuitry to detect one or more portions of the display device that are at least partially obscured from view further comprises circuitry to process signal energy accumulated by the at least some of the individually controllable emissive elements.

11. The controller device of claim 9, wherein the circuitry to detect one or more portions of the display device that are at least partially obscured from view further comprises circuitry to process signals generated by a front-facing camera.

12. The controller device of claim 11, wherein the front-facing camera is formed at least in part, from one or more of the plurality of individually controllable emissive elements configured as one or more light sensors.

13. The controller device of claim 12, wherein the affected control signals are further to reduce an image intensity to individually controllable emissive elements in the display device bordering the at least one of the one or more portions of the display device.

14. The controller device of claim 11, and further comprising:
circuitry to process the signals generated by the front-facing camera to track eye movement of a viewer; and
circuitry to affect a resolution in at least one portion of the display device based, at least in part, on the tracked eye movement of the viewer.

15. The controller device of claim 11, and further comprising:
circuitry to process signals from a touchscreen positioned over the display device to identify one or more touch points;
circuitry to determine the one or more portions of the display device that are at least partially obscured from view based, at least in part, on the detected one or more objects; and
circuitry to combine the identified one or more touch points and the detected one or more objects to determine the one or more portions of the display device that are at least partially obscured from view.

16. The controller device of claim 9, wherein:
the control signals are transmitted to the display device via a physical communication channel coupled between a display controller and the plurality of individually controllable emissive elements; and
further comprising circuitry to reallocate bandwidth in the physical communication channel based, at least in part, on the detected one or more portions.

17. The controller device of claim 9, wherein the control signals are based, at least in part, on one or more images rendered at a graphics processing unit (GPU) or video processing unit (VPU), and further comprising circuitry to affect operation of the GPU or VPU based, at least in part, on at least one of the detected one or more portions.

18. The controller device of claim 9, wherein the control signals are based, at least in part, on image signal intensity values stored in an image frame buffer and fetched by a composition controller and/or display controller, and further comprising circuitry to inhibit fetching, by the composition controller and/or display controller, of at least some of the image signal intensity value stored in the image frame buffer corresponding to at least one of the detected one or more portions.

19. The controller device of claim 9, and further comprising circuitry to reduce a quantity of image signal intensity values to be retrieved from an image frame buffer, the image signal intensity values corresponding to at least one of the one or more portions of the display device that are at least partially obscured from view.

20. A non-transitory computer-readable medium storing computer-readable code for fabrication of an apparatus comprising:
circuitry to detect one or more portions of a display device that are at least partially obscured from view, the display device comprising a plurality of individually controllable emissive elements, wherein the detected one or more portions of the display device that are at least partially obscured from view comprises circuitry to process signals from an image capture device to detect one or more objects in a line-of-sight of one or more viewers between the one or more viewers and the display device; and
circuitry to affect control signals to the display device to selectively reduce power to at least some of the individually controllable emissive elements corresponding to at least one of the one or more portions of the display device.
